(19) United States
(12) Patent Application Publication
(10) Pub. No.: US 2013/0044220 A1
(43) Pub. Date: Feb. 21, 2013

(54) METHOD AND SYSTEM FOR ENABLING REMOTE INSPECTION COMMUNICATION AND DOCUMENTATION

(71) Applicant: DANE DEMICELL, APTOS, CA (US)

(72) Inventor: DANE DEMICELL, APTOS, CA (US)

(21) Appl. No.: 13/214,030

(22) Filed: Aug. 19, 2011

(51) Int. Cl. H04N 7/18

(52) U.S. Cl. 348/158; 348/E07.085

(57) ABSTRACT

A method and device are provided that enable the establishment and at least partial recordation of a communications session between at least two electronic communications devices. In one application, a hand-held, mobile video-enabled device transmits video and/or photographic images of a location within a construction or remodeling site. The visual image date transmitted from the mobile device is received rendered at a remote computer and the visual data is analyzed in the context of a building, construction, tax, or safety regulation, code or standard. In an optional aspect, a graphic user interface may be employed at either or both the mobile device or the remote computer to add icons or other visual markers to one or more visual data frame sets. Visual data, text data, audio data, and/or pointers to other records may be associated with the each GUI icon or marker for later reference or further annotation.

### FIELD OF THE INVENTION

The present invention relates to the field mobile communications methods and devices. The present invention more particularly relates to initiating and documenting data associated with a mobile communication session.

### BACKGROUND OF THE INVENTION

Inspections and evaluations of buildings, equipment and remotely located persons or objects of interest are commonly desirable in the construction industry, public safety actions, public health operations, national borders customs enforcement, military settings, real estate appraisal and sales, market research, scientific investigations and marketing and behavioral studies.

The prior art does enable the establishment of video and audio data transmission sessions between a mobile communications device that is located at a site of interest and one or more remote computers, where the remote computers are remotely located from the mobile device. The prior art further allows the recordation and storage of video and audio data generated during one or more communications sessions.

Information associated with, or stored within, a record of a communication session is not always made easily accessible nor readily apparent in a later viewing or rendering of the stored record. Yet, the advantage of two or more parties to quickly identify and quickly apply the more important information as indicated in a stored record to a current analysis of the originating site, or other site of interest, can greatly increase the efficiency and effectiveness of parties who are cooperating in an inspection, analysis or investigation of (a.) a site of interest; (b.) conditions or aspects of a particular site, person or object; or (c.) higher interest aspects of remotely located persons or objects

Furthermore, the prior art fails to optimally provide for the documentation of information of particular, special or higher interest to one or more participants of a video communications session, or other viewers of the stored data or of a live communications session.

### SUMMARY OF THE INVENTION

Toward this and other objects that are made obvious in light of the disclosure, a method and system are provided that enable or comprise the establishment of a communications session wherein video data is transmitted from a mobile device at a site of interest to a remote computer. The communications session may be set at a predetermined time or according to a pre-established schedule.

According to a first aspect of the method of the present invention, a plurality of video frame data is transmitted from the mobile device to the remote computer. A bi-directional or unidirectional audio communications stream may simultaneously or near-simultaneously be established between the mobile device and the remote computer. Alternatively or additionally, a bi-directional or unidirectional text data communications stream may simultaneously or near-simultaneously be established between the mobile device and the remote computer.

According to a second aspect of the method of the present invention, a graphic user interface (“GUI”) may be applied by either or both the mobile device and the remote computer. The GUI may enable a user to impose a visual cursor and/or icon within a video image being rendered by the mobile device and/or the remote computer.

According to a third aspect of the method of the present invention, any and all data generated in a communications session, to include video data, textual data, audio data and GUI data, may be recorded in a session record. Optionally, additional data may be recorded and stored within, associated with, or associable with, and earlier or later recorded session record.

According to a fourth aspect of the method of the present invention, the communications session may satisfy or attempt to satisfy a requirement of an inspection process or protocol, such as an inspection made in accordance with a determination of compliance of a building with a governmental zoning or construction code.

According to a fifth aspect of the method of the present invention, a GUI icon may be associated with a particular aspect or quality of information. For example, a first GUI icon may indicate an electrical inspection code violation, or generally relate to an electrical aspect of a construction code. In another example, a second GUI icon may indicate a priority or severity level of an aspect of a feature presented in a video image.

### INCORPORATION BY REFERENCE

All publications mentioned herein are incorporated herein by reference to disclose and describe the methods and/or materials in connection with which the publications are cited. All publications, patents, and patent applications mentioned in this specification are herein incorporated by reference in their entirety and for all purposes to the same extent as if each individual publication, patent, or patent application was specifically and individually indicated to be incorporated by reference.

Such incorporations include U.S. Pat. No. 6,175,380 (inventor: Van Den Bosch, J.; issued Jan. 16, 2001) titled “Method for randomly accessing stored imagery and a field inspection system employing the same”; U.S. Pat. No. 6,501,501 (inventor: Miyazawa, T.; issued Dec. 31, 2002) titled “Construction and civil engineering database generator and display”; U.S. Pat. No. 6,614,916 (inventor: MacDonald, V.; issued Sep. 2, 2003) titled “Machine vision system and triggering method”; U.S. Pat. No. 7,215,811 (inventors: Moselhi, et al.; issued May 8, 2007) “Method and apparatus for the automated detection and classification of defects in sewer pipes”; and U.S. Pat. No. 7,330,510 Castillo, et al.; issued Feb. 12, 2008) titled “Method for displaying base frames during video data decompression”.

The publications discussed or mentioned herein are provided solely for their disclosure prior to the filing date of the present application. Nothing herein is to be construed as an admission that the present invention is not entitled to antedate such publication by virtue of prior invention. Furthermore, the dates of publication provided herein may differ from the actual publication dates which may need to be independently confirmed.

### BRIEF DESCRIPTION OF THE FIGURES

These, and further features of various aspects of the present invention, may be better understood with reference to the accompanying specification, wherein:

FIG. 1 illustrates a wireless communications network;

FIG. 2 is a schematic of the mobile communications device of FIG. 1;

FIG. 3 is a schematic of the software modules of the mobile communications device of FIGS. 2 and 3;

FIG. 4 is a schematic of the remote computer of FIG. 1;

FIG. 5 is a schematic of the software modules of the remote computer of FIGS. 1 and 4;

FIG. 6 is a process chart of a prior art inspection session;

FIG. 7 is a process chart of a communications session established between the mobile device and the remote computer of FIG. 1;

FIG. 8 is a flowchart of the operations of the mobile device of FIG. 1 in accordance with the communications session of FIG. 7;

FIG. 9 is a flowchart of the operations of the remote computer of FIG. 1 in accordance with the communications session of FIG. 7;

FIG. 10 is a schematic diagram showing a plurality of session records of as optionally stored in the network, one or more mobile devices, and one or more remote computers of FIG. 1;

FIG. 11 is a schematic illustration of one possible embodiment of a first session record of FIG. 10;

FIG. 12 is a schematic illustration of an inspection site;

FIG. 13 is a flowchart of an alternate preferred embodiment of the method of the present invention that may be executed by the mobile communications device of FIGS. 1 and 2 in communication with the remote computer of FIGS. 1 and 4;

FIG. 14 is a schematic illustration of one possible embodiment of a second session record of FIG. 10; and

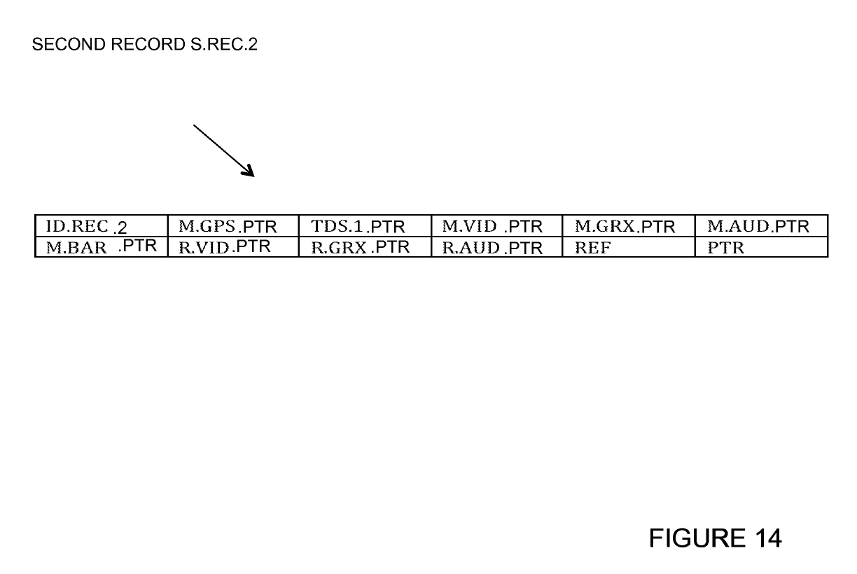

FIG. 15 is a schematic illustration of a plurality of data referenced by the second session record of FIG. 14 as optionally stored in the network, one or more mobile devices, and one or more remote computers of FIG. 1.

### DESCRIPTION

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

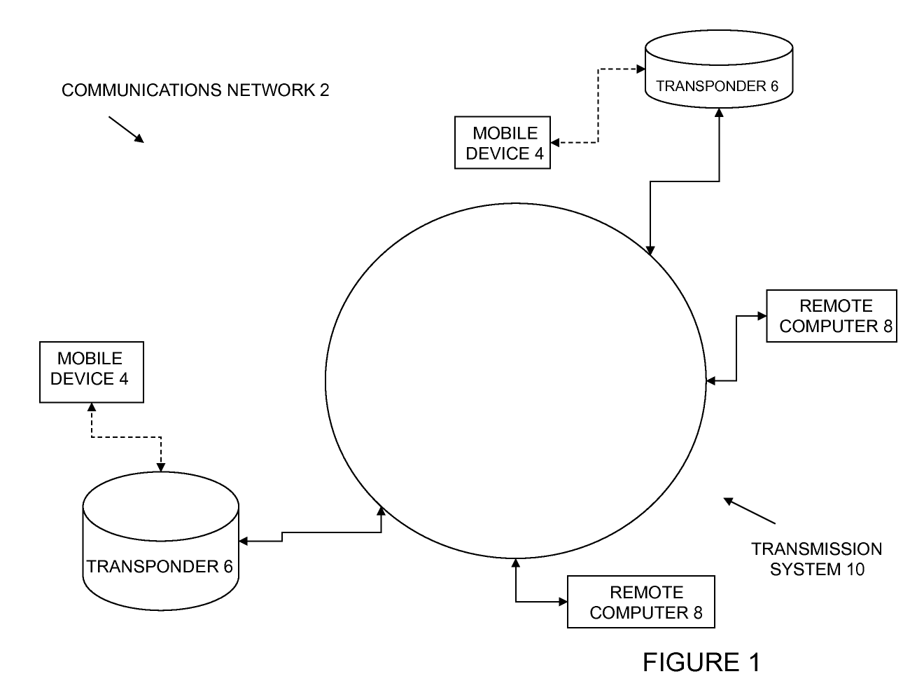

Referring now generally to the Figures and particularly to FIG. 1, FIG. 1 illustrates a wireless communications network 2. A mobile communications device 4 (hereinafter, “mobile device”) 4 is bi-directionally communicatively coupled to a wireless transponder 6. The wireless transponder 6 is coupled to a plurality of remote computers 8 (hereinafter, “remote computers”) via a hard-wired electronic digital communications transmission system 10 (hereinafter, “transmission system” 10). It is understood that the transmission system 10 may comprise, or be comprised within, the Internet, a telephony network and be or comprise continuous electrically connective cables, optical fibers, communications cabling, and additional wireless communications transponders and linking wireless communications systems. The mobile device 4 and one or more of each of plurality of alternate mobile devices 4 are enabled for bi-directional communication with one or more additional transponders 6.

It is understood that the mobile device 4 may be a video-capture enabled communications device, such as a video-capture enabled cellular telephone, to include (a.) an iPhone 4™ as marketed by Apple Computer of Cupertino, Calif.; (b.) an iPad™ touch screen tablet personal computer as marketed by Apple Computer of Cupertino, Calif.; (c.) a video-capture enabled cellular telephone enable to, and executing, Android™ open-source software stack provided by, or in conjunction with, Google, Inc. of Mountain View, Calif.; (d.) or other suitable video-enabled portable electronic communications cellular telephone, voice-over Internet enabled and video-enabled portable electronic communications device, or video-enabled portable electronic communications portable communications device known in the art.

It is understood that one or more remote computers 8 may be or comprise (a.) a video-capture enabled communications device; (b.) a VAIO FS8900™ notebook computer marketed by Sony Corporation of America, of New York City, N.Y., (c.) a SUN SPARCSERVER computer workstation marketed by Sun Microsystems of Santa Clara, Calif. running LINUX or UNIX operating system; (d.) a personal computer configured for running WINDOWS XP™ operating system marketed by Microsoft Corporation of Redmond, Wash.; (e.) a PowerBook G4™ personal computer as marketed by Apple Computer of Cupertino, Calif.; (f.) an Alienware M17x™ personal computer as marketed by the Dell Corporation; (g.) a Macbook Pro™ personal computer as marketed by Apple Computer of Cupertino, Calif.; or (h.) an internet enabled desktop computer; (h.) an iPad™ touch screen tablet personal computer as marketed by Apple Computer of Cupertino, Calif.; or (j) other suitable computational device adapted to receive and render digitized video data known in the art.

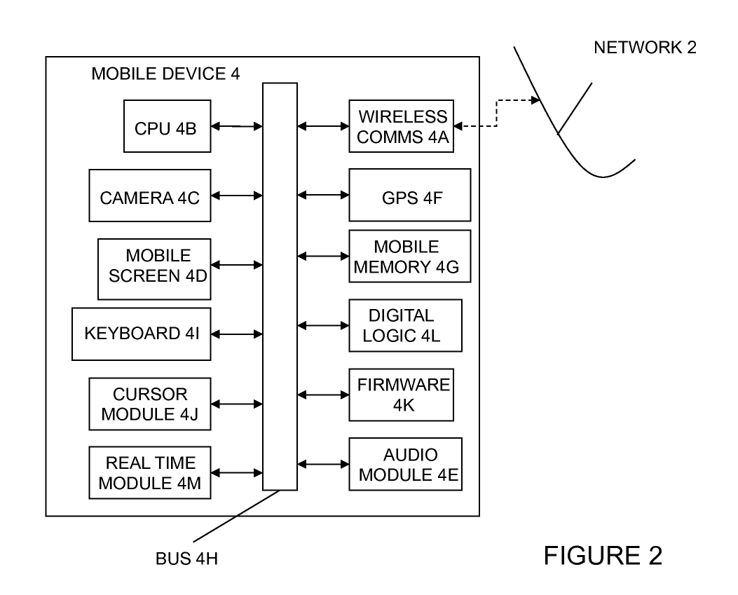

Referring now generally to the Figures and particularly to FIG. 2, FIG. 2 is a schematic of the mobile device 4. The mobile device 4 includes a wireless communications module 4A, a central processing unit 4B (hereinafter, “mobile CPU”), a digital camera 4C, a mobile video display screen 4D, an audio module 4E, and a global positioning system module 4F, and a mobile system electronic sold-state memory 4G (hereinafter, “mobile memory” 4G). The mobile video display screen 4D (hereinafter, “mobile screen” 4D) may optionally include touch-screen capability and be adapted to sense mechanical pressure and/or heat that the mobile device 4 is programmed to interpret and accept as instructions and/or actionable selections.

The global positioning system module 4F (hereinafter, “the GPS” 4F) is adapted and enabled to receive wireless radio wave signals from a global positioning system

The wireless communications module 4A, the mobile CPU 4B, the digital camera 4C, the mobile screen 4D, the audio module 4E, the global positioning system module 4F and mobile memory 4G are communicatively coupled via an internal device communications bus 4H. The mobile device 4 may optionally include a digital keyboard 4I and/or a cursor control module 4J, that are each or both additionally coupled via the internal device communications bus 4H to the mobile CPU 4B, the wireless communications module 4A, the camera 4C, the mobile screen 4D, the audio module 4E, and/or the mobile memory 4G. It is understood that the mobile device 4 may optionally include one or more optional peripheral memories, one or more firmware 4K, and/or one or more optional programmable logic 4L that are each or both additionally coupled via the internal device communications bus 4H to the mobile CPU 4B, the wireless communications module 4A, the digital camera 4B, the mobile screen 4D, the audio module 4E, and/or the mobile memory 4G. The optional peripheral memories, one or more firmware 4K, and/or one or more optional programmable logic 4L may provide machine-executable instructions and the mobile CPU 4B, the wireless communications module 4A, the digital camera 4B, the mobile screen 4D, the audio module 4E, and/or the mobile memory 4G.

It is understood that the mobile device 4 may optionally include a time date real time clock 4M (or “real time module” 4M) that provides time date stamp data to, and coupled via the internal device communications bus 4H with, the mobile CPU 4B, the wireless communications module 4A, the digital camera 4B, the mobile screen 4D and/or the mobile memory 4G.

The audio module 4E comprises audio input circuitry that receives and digitizes sound wave energy into audio data files and transmits the digitized audio data files via the internal device communications bus 4H, the wireless communications module 4A, and the network 2 to one or more additional mobile devices 4 and/or remote computers 8. The audio module 4E further comprises audio output circuitry that receives remote digitized audio data files via the internal device communications bus 4H, the wireless communications module 4A, and the network 2 from one or more additional mobile devices 4 and/or remote computers 8, and converts the remote audio digital files into sound energy emitted by the mobile device 4.

The digital camera comprises image capture circuitry that receives and digitizes light energy into video data files and transmits the digitized video data files via the internal device communications bus 4H, the wireless communications module 4A, and the network 2 to one or more additional mobile devices 4 and/or remote computers 8. It is understood that the video data files may contain solely graphics data, or video data and graphics data, that may be rendered by the remote systems 8 and/or the additional mobile devices.

The mobile screen 4D comprises video input circuitry and display circuitry that receives and visually renders digitized video data files received from and generated by one or more mobile devices 4 and/or additional remote computers 8. The digitized video data files are transmitted to the mobile device 4 via the wireless communications module 4A and the network 2. It is understood that the video data files may contain solely graphics data, or video data and graphics data, that may be rendered by the mobile screen 4D.

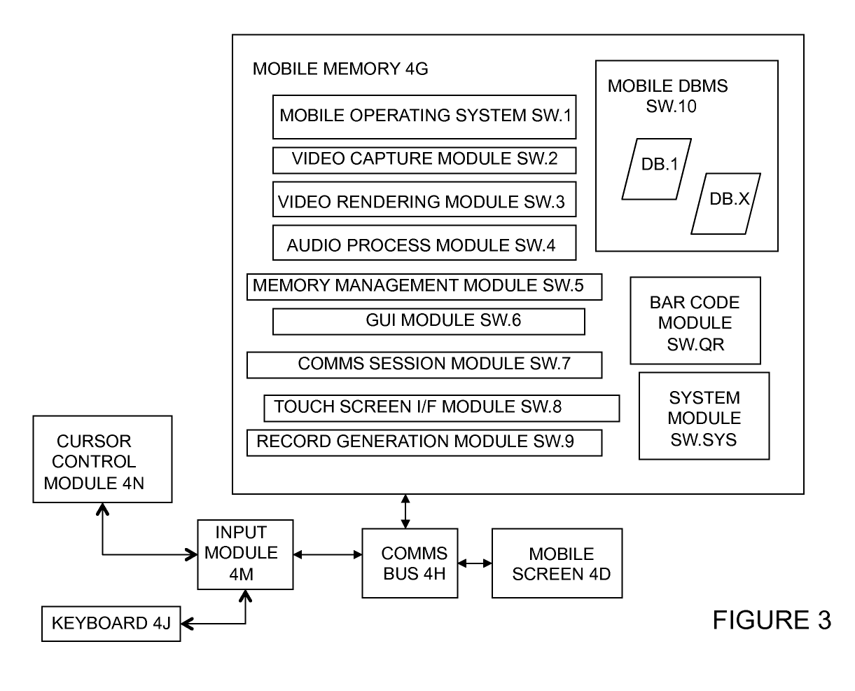

Referring now generally to the Figures and particularly to FIG. 3, FIG. 3 is a schematic of a suite of software modules SW.1-SW.10 of the mobile device 4. One or more software modules SW.1-SW.10 may be stored entirely within, or distributed in parts among, the mobile memory 4G, one or more firmware 4K, one or more peripheral memories, and/or one or more optional programmable logic 4L.

A mobile operating system software module SW.1 includes software programs SW.2-SW.10 and data D.1-D.X sufficient to control and manage computer hardware 4A-4L resources of the mobile device 4 to enable the provision of necessary services within the mobile device 4 for execution of various application software SW.2-SW.10 and to instantiate features and aspects of the method of the present invention and execute software code accessible to the mobile device 4. The mobile operating system SW.1 may be (a.) an iPhone OS™ mobile device operating system; (b.) and Android™ software stack for mobile devices that includes an operating system, middleware and key applications as provided by Google, Inc. of Mountain View, Calif. and the Open Handset Alliance of Mountain View, Calif.; (c.) other suitable mobile device operating systems known in the art.

The software module suite of the mobile device 4 further includes a video data capture module SW.2, a video rendering module SW.3, an audio processing software SW.4, a memory management module SW.5, a graphic interface module SW.6, a communications session module SW.7, an optional touch screen interface module SW.8, and a record generation software SW.9, and a database management software SW.10. The database management software SW.10 (hereinafter, “DBMS” SW.10) includes at least one database DB.1-DB.X.

The video data capture module SW.2 enables the mobile device 2 to form and populate video files from digital imaging data generated by the mobile digital camera 4D and transmit the video data files to the remote computer 8 via the wireless comms module 8A.

The video rendering module SW.3 enables the mobile screen 4D to visually render data harvested from video data files.

The audio processing software SW.4 enables the audio module 4E to generate audio data files from analog to digital conversion of sound energy and render audible signals from audio data files.

The memory management module SW.5 enables the CPU 4B to manage the mobile memory 4G, the digital logic 4K, peripheral memory and/or the firmware 4K

The graphic interface module SW.6 (hereinafter, the “GUI module” SW.6) enables the mobile device 2 to form, modify and fully or partially populate video files as well as data content of session records S.REC.1-S.REC.N, with graphics data, video data, and audio alphanumeric data interpreted from data input received from the audio module 4E, keyboard 4I, the cursor module 4J, the cursor control module 4N, the mobile CPU 4B and/or the wireless comms interface 4A. The graphic interface module SW.6 further enables the mobile device 2 to render graphics data by means of the mobile screen 4D, as harvested from video data files and/or from data interpreted from data input received from the keyboard 41, the cursor module 4J, the cursor control module 4N, the mobile CPU 4B and/or the wireless comms interface 4A.

The communications session module SW.7 enables the wireless comms interface 4A to bi-directionally communicatively couple the mobile device 4 with one or more remote computers 8 and/or additional mobile computers 4 via the network 2. The communications session module SW.7 further enables the wireless comms interface 4A to receive and transmit via the network 2 (a.) information; (b.) video data files; (c.) audio data files; and (d.) instructions.

The optional touch screen interface module SW.8 enables the mobile device 2 to interpret data input received from the display screen 4D from heat and/or mechanical force or pressure and provide the data to the mobile CPU 4B as commands, data and/or instructions.

The record generation software SW.9 enables the DBMS 10 to generate records, to include in one or more session records S.REC.1-S.REC.N, that may be stored in one or more databases DB.1-DB.X and/or transmitted from the mobile device 4 to one or more remote computers 8 and/or additional mobile devices 4.

The database management software SW.10 enables the mobile device 4 to control the create, maintain, and use databases DB.1-DB.X and records stored therein.

The bar code module SW.QR enables the mobile device 2 to form and populate video files from digital imaging data generated by interpreting QR bar codes and/or other visual bar code images detected by the mobile digital camera 4D into text, image, and/or other data types and to transmit the interpreted data to the remote computer 8 via the wireless comms module 8A.

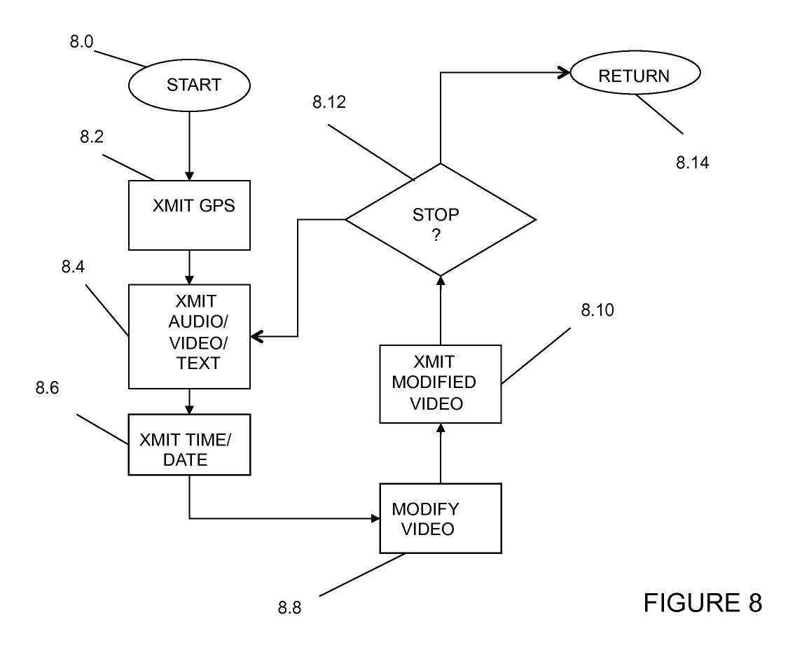

System software module SW.SYS enables the mobile device 4 to apply the mobile device hardware elements 4A-4M and the mobile device software elements SW.1-SW.10 & SW.QR to perform the operations of the method of FIG. 8.

An input module 4M of the mobile device 4 may be adapted to receive cursor control instructions and directions provide by heat and/or manual touch force by a user from an optional cursor control input module 4N of the mobile device 4. The cursor control INPUT module 4N may include a mouse, a mouse pad, a track ball and/or other data input, instruction input and selection devices known in the art. The input module 4M is further communicatively coupled to the keyboard 41 and the comms bus 4H, and provides selections, commands and data input by the user of the mobile device 4 to the CPU 4B, the wireless communications module 4A and the mobile memory 4G from the keyboard 41 and the optional cursor control module 4N.

The GUI module SW.6 interprets graphics data and instructions input via the cursor module 4J, the keyboard 41, the cursor control input device 4N, CPU 4B, the internal communications bus 4H and the wireless communications interface 4A and alternatively or contemporaneously (a.) stores the graphics data and instructions in one or more video data files DBMS SW.10; (b.) provides the graphics data and instructions for rendering by the mobile screen 4D; and/or (c.) enables the mobile device 4 to transmit the graphics data and instructions within one or more video data files to one or more additional mobile devices 4 and/or remote computers 8.

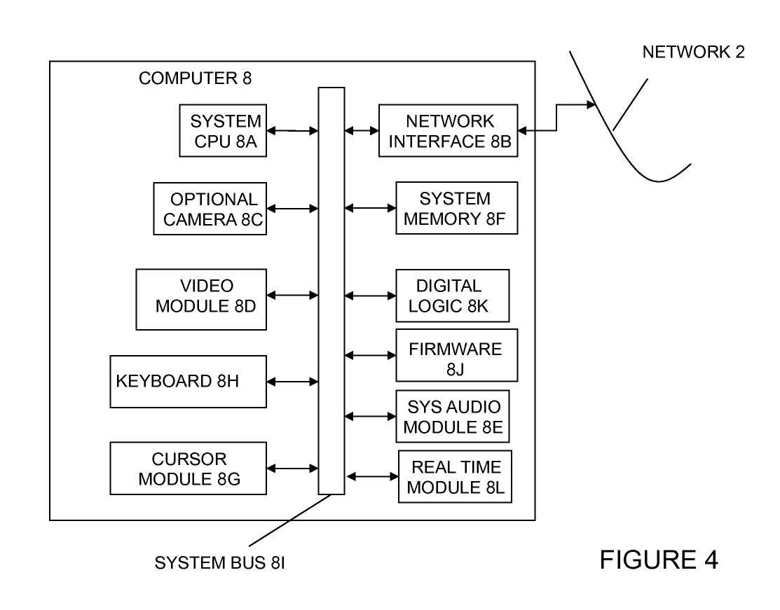

FIG. 4 is a schematic of the remote computer 8. It is understood that the remote computer 8 is remotely located from the mobile device 4 and is bi-directionally communicatively coupled with the mobile device 4 via the communications network 2. The remote computer 8 includes a system central processing unit 8A (hereinafter “system CPU”) 8A, a network interface module 8B, an optional system camera 8C, a system video rendering module 8D, a system audio module 8E, a system memory 8F, a cursor control module 8G and a digital keyboard module 8H. An internal system communications bus 81 communicatively couples the system CPU 8A, the network interface module 8B, the optional system camera 8C, the system video rendering module 8B, the system audio module 8E, the system memory 8F, the cursor control module 8G and the digital keyboard module 8H.

The system audio module 8E comprises system audio input circuitry that receives and digitizes sound wave energy into audio data files and transmits the digitized audio data files via the internal device communications bus 81, the network interface 8B and the network 2 to one or more additional mobile devices 4 and/or remote computers 8. The system audio module 8E further comprises system audio output circuitry that receives remote digitized audio data files via the internal device communications bus 81, the network interface 8B and the network 2 from one or more mobile devices 4 and/or additional remote computers 8, and converts the remote audio digital files into sound energy emitted by the system audio module 8E.

The system video display module 8D comprises system video input circuitry and display circuitry that receives and visually renders digitized video data files generated by one or more mobile devices 4 and/or additional remote computers 8. The digitized video data files are transmitted to the remote computer 8 via the system device communications bus 81, the network interface 8B and the network 2. It is understood that the video data files may contain solely graphics data, or video data and graphics data, that may be rendered by the system video display module 8D.

It is understood that the remote computer 8 may optionally include a time date real time clock 8L (or “system real time module” 8L) that provides time date stamp data to, and coupled via the system communications bus 81 with, the system CPU 8A, the network interface 8B, the optional system digital camera 8C, the video module 8D and/or the system memory 8F.

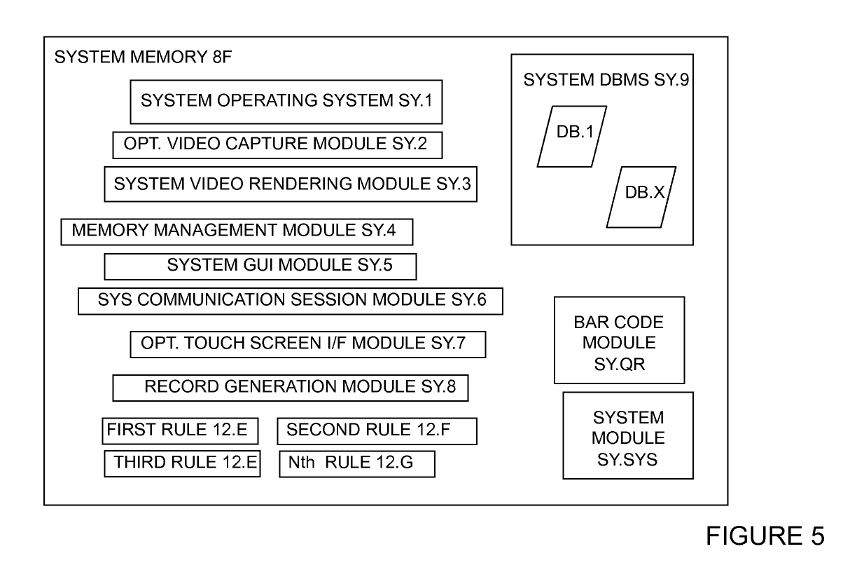

FIG. 5 is a schematic of the software modules SY.1-SY.9, SY.SYS & SY.QR of the remote computer 8. One or more software modules SY.1-SY.X may be stored entirely within, or distributed in parts among, the system memory 8F, one or more optional firmware 8J, one or more peripheral memories, and/or one or more optional programmable logic circuits 8K.

A system operating system software module SY.1 includes software programs and data sufficient to control and manage computer hardware resources of the remote computer 8 to enable the provision of necessary services within the remote computer 8 for execution of various application software and to instantiate features and aspects of the method of the present invention and execute software code accessible to the remote computer 8. The system operating system 8 may be (a.) a LINUX or UNIX operating system; (d.) a WINDOWS XP™ operating system marketed by Microsoft Corporation of Redmond, Wash.; (c.) a Mac OS™ operating system; (d.) an iPhone OS™ mobile device operating system; (e.) and Android™ software stack for mobile devices that includes an operating system, middleware and key applications as provided by Google, Inc. of Mountain View, Calif. and the Open Handset Alliance of Mountain View, Calif.; or (f.) an other suitable computer operating system known in the art.

The system software module suite of the remote computer 8 includes an optional system video data capture module SY.2, a system video rendering module SY.3, a system memory management module SY.4, a system graphic interface module SY.5, a system communications session module SY.6, an optional system touch screen interface module SY.7, a system record generation software SY.8, and a system database management software SY.9. The database management software SW.9 (hereinafter, “system DBMS” SY.9) includes at least one database DB.1-DB.X.

The system graphic interface module SY.5 (hereinafter, the “system GUI module” SY.5) receives and interprets graphics data, video data, and audio alphanumeric data interpreted from data input received from the audio module 4E, and/or input via the system cursor module 8J, the system keyboard 8H, the cursor control input device 8J, CPU 4B, the system communications bus 81 and/or the network communications interface 8B. The system GUI module SY.5 optionally, alternatively and/or contemporaneously may be adapted and configured to (a.) store and modify the graphics data, video data, and alphanumeric data and instructions in one or more session records S.REC.1-S.REC.N and/or video data files of the DBMS SY.10; (b.) provide the graphics data, video data, and alphanumeric data and or instructions stored within or associated with one or more session records S.REC.1-S.REC.N and/or video data files of the DBMS SY.10 for rendering by the video display module 8D; and/or (c.) enable the remote computer 8 to transmit the video data, and alphanumeric data and instructions stored within or associated with one or more video data files to one or more additional mobile devices 4 and/or remote computers 8.

The bar code module SY.QR enables the remote computer 4 to form and populate video files from digital imaging data generated by interpreting QR bar codes and/or other visual bar code images detected by the optional digital camera 8C into text, image, and/or other data types and to transmit the interpreted data to the mobile device 4 via the wireless comms module 8A, and alternately or additionally store the interpreted data into one or more session files S.REC.1-S.REC.N.

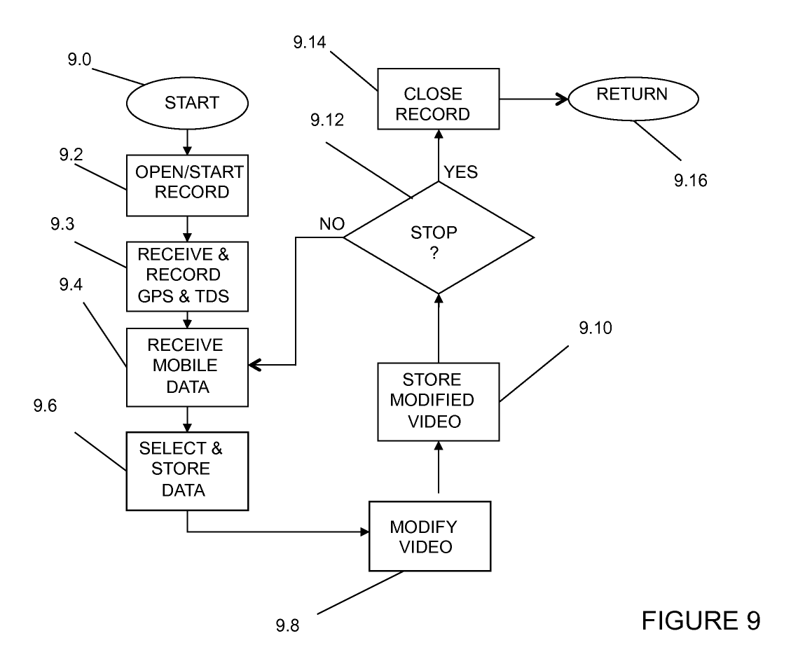

Computer system software module SW.SYS enables the remote device 8A-*K to apply the mobile device hardware elements 4A-4M and the mobile device software elements SY.1-SY.10 & Y.QR to perform the operations of the method of FIG. 9.

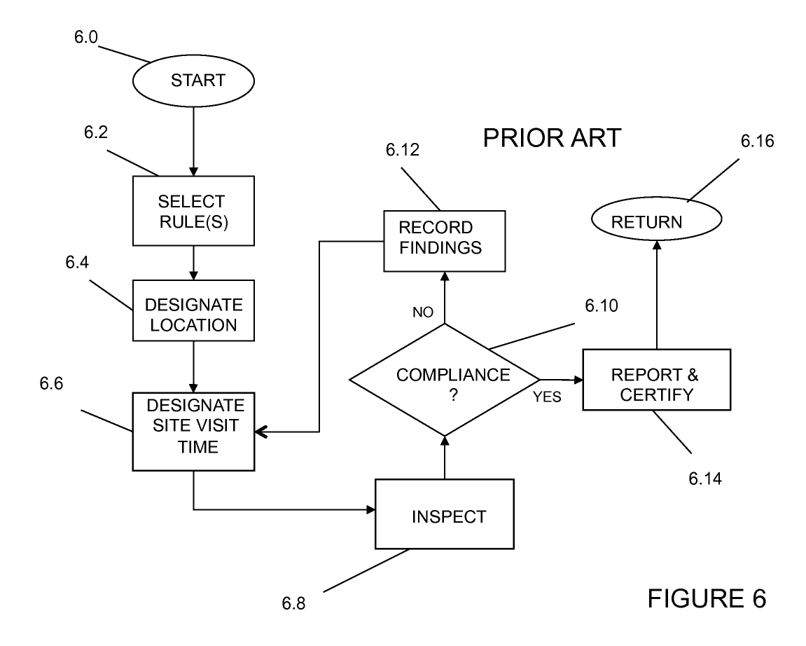

FIG. 6 is an illustration of a prior art process, wherein an inspector is required to personally visit a construction site in order to evaluate compliance with a pre-established standard. One or more rules, e.g., rules or regulations, that define a standard that will be applied to a remote site are selected in step 6.2. The location of the site where the rule or rules are to be compared to for compliance is designated in step 6.4. An inspector visit appointment is established in step 6.6, and in step 6.8 an inspection of the site is conducted by the inspector wherein one or more aspects of the site are evaluated for compliance with the rule or rules selected in step 6.2.

The inspector determines whether or not the relevant aspects of the site are in compliance with the rule(s) in step 6.10. When the inspector determines in step 6.10 that the relevant aspects of the site are not in compliance with the rule(s) of step 6.2, the inspector typically records the finding of the inspection of step 6.8 and often makes an appoint for another inspection in a repeated performance of step 6.6.

When the inspector determines in step 6.10 that the relevant aspects of the site are in acceptable or substantive compliance with the rule(s) of step 6.2, the inspector typically records the finding of the inspection of step 6.14 and certifies that the site is in compliance with the rule(s) of step 6.2.

This prior art process is often wasteful of time and resources and typically requires that individual workers or teams of workers to stand idle while waiting for on-site inspections to commence and be completed.

Referring now generally to the Figures and the Description, an exemplary digitized electronic first session record S.REC.1 is referred to for the purpose of illustrating several aspects of the method of the present invention, it is understood that that processes disclosed and aspects of the invented system presented below as applied to the first session record S.REC.1 are generally and specifically applicable, in whole or in part, to various alternate digitized electronic session records S.REC.2-S.REC.N.

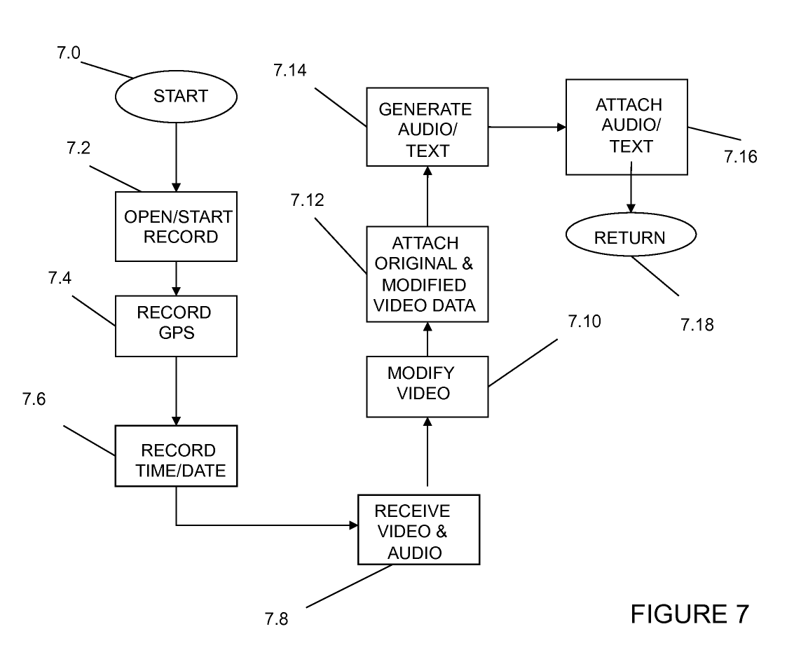

FIG. 7 is a process chart of a communications session established between the mobile device 4 and the remote computer 8. An informant resides at a construction site and uses the mobile device 4 while an inspector operates the remote computer 8 at a location outside of site of the construction site.

The exemplary digitized electronic first session record S.REC.1 ((hereinafter, “first record” S.REC.1) is opened or initialized in step 7.2. A GPS data transmitted from the mobile device 4 is recorded in the first record S.REC.1 in step 7.4. A time date stamp datum is written into the first record S.REC.1 in step 7.6. The time date stamp datum of step 7.6 may be provided or generated by the real time module 4M of the remote device and/or the system real time module 8L of the remote computer 8. Video and audio data is transmitted from the mobile device 4 by the informant and received by the remote computer 8 in step 7.8. The video data is modified with graphics data generated by the mobile device 4 by the informant and/or the remote computer 8 by the inspector in step 7.10. Original video data transmitted from the mobile device 4 is attached to the first record S.REC.1 as well as video data modified in step 7.10, as selected by the inspector. Digitized audio and text data is selected in step 7.14 and selected text and audio data is attached to the first record S.REC.1 in step 7.16.

FIG. 8 is a flowchart of the operations of the mobile device 4 in accordance with the communications session of FIG. 7. The mobile device 4 transmits a GPS datum generated by the device GPS 4F while the mobile device 4 is in place at the construction site in step 8.2. The informant initiates transmission from the mobile device 4 to the remote computer 8 in step 8.4 of (a.) video data as generated by the digital camera 4C; (b.) audio data as generated by the device audio module 4E; and/or (c.) text data generated by application of input devices 4J, 4K & 4N and/or mobile CPU 4B of the mobile device 4. A data time stamp datum is generated and transmitted from the mobile device 4 to the remote computer 8 in step 8.6. The time date stamp datum of step 8.6 may be provided or generated by the real time module 4M of the remote device and/or the system real time module 8L of the remote computer 8. Video data sourced from the mobile device camera 4C is modified by the informant step 8.10 with graphics data, alphanumeric data, and/or audio generated by the informant's application of the GUI module SW.6. The video data modified in step 8.8 is transmitted in step 8.10 as directed by the informant from the mobile device 4 to the remote computer 8. The informant directs the mobile device 4 to proceeds from step 8.12 to (a.) to execute another cycle of steps 8.4 to 8.12; or to step 8.14 and to cease transmission of data from the mobile device 4, whereby the communications session started in step 8.2 ends.

FIG. 9 is a flowchart of the operations of the remote computer 8 in accordance with the communications session of FIG. 7 and FIG. 8. The inspector opens or generates a new session record S.REC.1-S.REC.N in step 9.2 and receives the GPS datum and time date stamp and records some or all of this received data in step 9.3. Optionally the time date stamp datum of step 9.3 may be provided or generated in whole or in part by the real time module 4M of the remote device and/or the system real time module 8L of the remote computer 8. Video, audio QR codes and/or text data next received from the mobile device 4 in step 9.5, and the inspector directs the remote computer 8 to selectively store elements of this data, as well data input to the remote computer 8 by the inspector, into the first record S.REC.1 in step 9.6. The inspector optionally and selectively applies the system GUI SY.5 in step 9.8 to modify selections of the video data received from the mobile device, and directs the remote computer 8 to store the modified video data, the modified video data comprising a combination or synthesis of video data and graphics data. The inspector the determines whether to continue the instant communications session by directing the remote computer 8 to proceed from step 9.12 to execute another cycle of steps 9.4 through 9.12. Alternately, the inspector may direct the remote computer 8 to proceed to step 9.14 and to close the first record S.REC.1, and then from step 9.14 to step 9.16 and to perform alternate computational and/or communications processes.

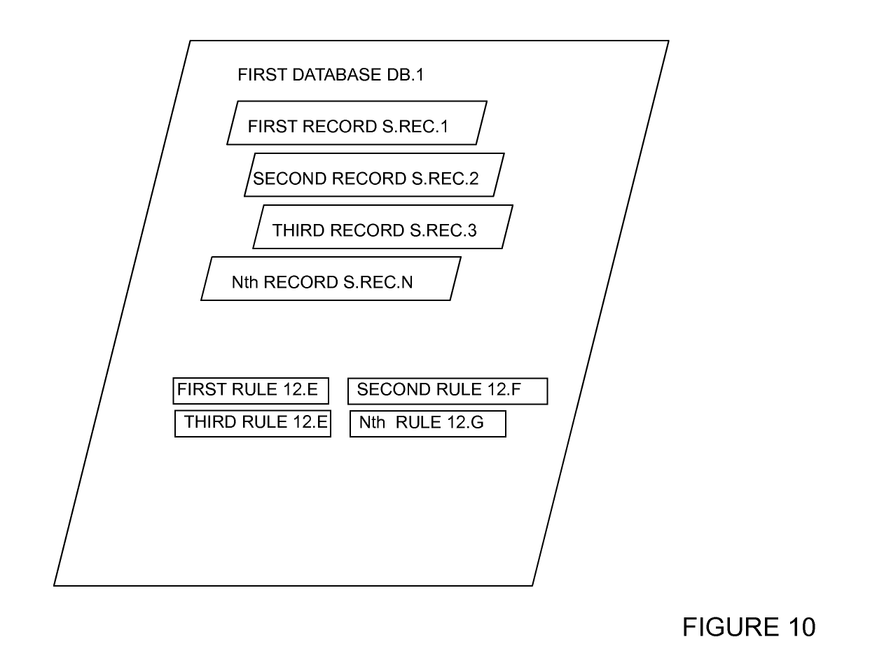

FIG. 10 is a schematic diagram showing the plurality of session records S.REC.1-S.REC.N as stored in an exemplary first database DB.1. It is understood that the first database DB.1 may be located in and/or replicated more than once within, the mobile device 4, the remote computer 8 and/or elsewhere within the network 2.

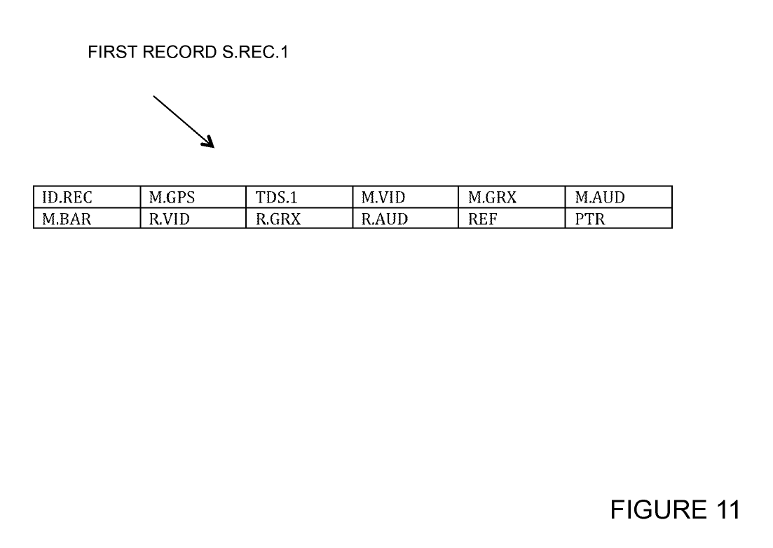

Referring now to the Figures and particularly to FIG. 11, FIG. 11 is a schematic illustration of one possible embodiment of the first record S.REC.1. It is understood that each and every aspect and feature of the first record S.REC.1 disclosed may separately and generally applied or instantiated in one or more additional session records S.REC.2-S.REC.N.

The first session record includes a record identifier ID.REC that uniquely identifies the first session record S.REC.1 to the mobile DBMS SW.10 and/or the system DBMS SY.9; a GPS data M.GPS generated by the mobile device 4; a time date data TDS.1 generated by the mobile device 4 and/or the remote computer 8; a video data M.VID generated by the mobile device 4; a graphics data M.GRX generated by the mobile device 4; an audio data M.AUD generated by the mobile device 4; a derived data M.BAR interpreted from bar code images, to include QR images, wherein the derived data is generated by the mobile device 4 and/or the remote computer 8; a video data R.VID generated by the remote computer 8; a graphics data R.GRX generated by the remote computer 8; an audio data R.AUD generated by the remote computer 8; a derived data R.BAR interpreted from bar code images, to include QR images, wherein the derived data is generated by the remote computer 8.; and/or references REF and pointers PTR to additional data stored within and/or available to or via one or more mobile devices 4, one or more remote computers 8, and/the network 2.

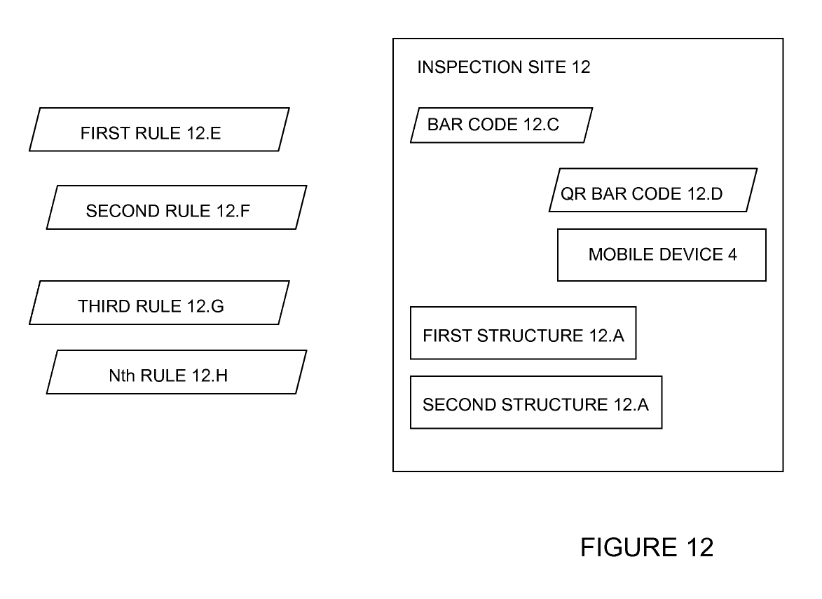

Referring now to the Figures and particularly to FIG. 12, FIG. 12 is a schematic illustration of an inspection site 12 having a first structure 12.A and a second structure 12.B. The first structure 12.A and/or the second structure 12.B may be or comprise plumbing elements, roofing elements, structural support elements, electrical wiring and/or electrical components, structural support elements and/or other suitable structures, feature or elements known in the art. A bar code pattern 12.C and/or a QR bar code pattern 12.D are located within or adjacent to the inspection site 12 and are encoded to provide information related to or describing the inspection site 12, the first structure 12.A and/or the second structure 12.B.

A plurality of codified rules 12.E-12.H may be provided to an inspector in a hard copy format and or digitized and stored within the memory 4G of the mobile device 4 and/or the system memory 8F of on or more remote computers 8. The rules provide inspection criteria useful for the inspector in conducting an inspection and for the inspector or a third party to determine compliance of an aspect of the first structure 12.A and/or the second structure 12.B with a selected rule.

The mobile device is temporarily located within the inspection site 12 for use by the inspector in the inspection of the inspection site 12, the first structure 12.A and/or the second.

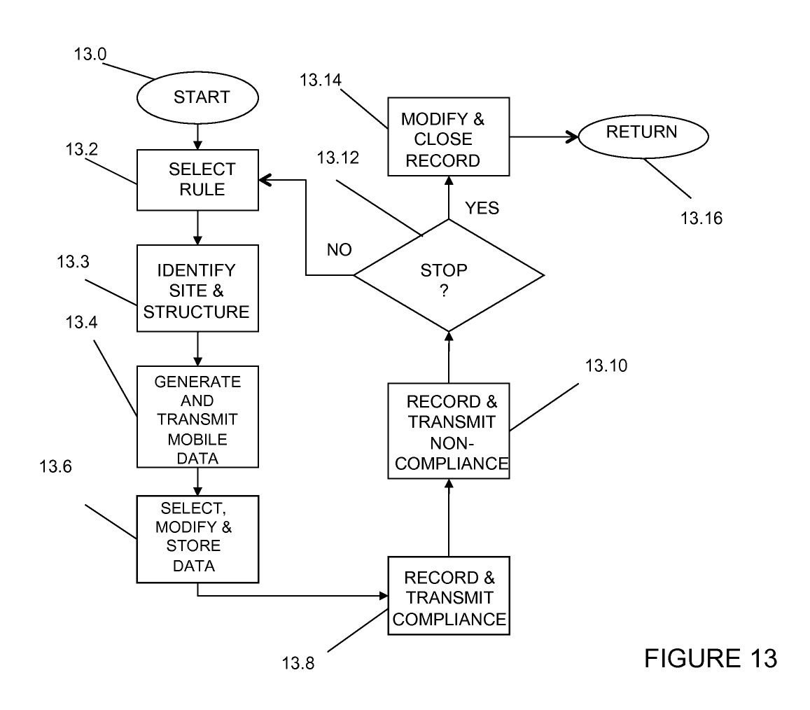

Referring now to the Figures and particularly to FIG. 13, FIG. 13 is a flowchart of an alternate preferred embodiment of the method of the present invention that may be executed by the mobile communications device 4 in communication with the remote computer 8. In step 13.2 the plurality of rules 12.E-12.H are established and the exemplary first rule 12.E is selected from the plurality of rules 12.E-12.H, wherein the selection of the first rule 12.E is made by the inspector or by an operator of the remote computer 8. The exemplary inspection site 12 is selected and identified, and optionally the exemplary first structure 12.A, is selected and identified in step 13.3. The inspector generates data acquired at or related to the inspection site 12, the first structure 12.A and/or first rule 12.A, and transmits the generated data to the remote computer 8 from the mobile device 4 in step 14.3. The inspector may by means of the mobile device 4 select, modify and store data generated in step 13.4 in the execution of step 13.6; the operator of the remote computer 8 may alternatively, optionally and/or additionally may, by means of the remote compute 8, select, modify and store data generated in step 13.4 in the execution of step 13.6 in by means of one or more session records S.REC.1-S.REC.N. The inspector or operator may record and/or transmit a holding of partial or entire compliance of the inspection site and/or the first structure 12.A with the exemplary first rule 12.E in step 13.8. Alternatively, optionally and/or additionally the inspector or operator may record and/or transmit a holding of partial or entire noncompliance of the inspection site and/or the first structure 12.A with the exemplary first rule 12 in step 13.10.

The inspector and/or operator may elect in step 13.12 to repeat one or more of process of steps 13.2 through 13.12 and thereby apply the first rule 12.E or another rule or rules 12.E-12.H in an inspection of the second structure 12.B and record the findings of such an inspection in one or more session records S.REC.1-S.REC.N. In step 13.14 the inspector and/or operator may elect modify and close one or more session records as stored in the mobile device 4 and/or the remote computer 8. The inspector and/or operator proceed on to other activities in step 13.16.

The second session record includes a second record identifier ID.REC.2 that uniquely identifies the second session record S.REC.2 to the mobile DBMS SW.10 and/or the system DBMS SY.9; a GPS pointer M.GPS.PTR that references a second GPS datum M.GPS.2; a time/data stamp pointer TDS.1 that references a second time date datum TDS.2; a video data pointer M.VID.PTR that references a second video data M.VID.2 generated by the mobile device 4; a graphics data pointer M.GRX.PTR that points to a second graphics data M.GRX.2 generated by the mobile device 4; an audio data pointer M.AUD.PTR that references a second audio data M.AUD.2 generated by the mobile device 4; the derived data pointer M.BAR.PTR that references a second derived data M.BAR.2 generated by the mobile device 4; a video data pointer R.VID.PTR that references a second video data R.VID.2 generated by the remote computer 8; a graphics data pointer R.GRX.PTR that references a second graphics data R.GRX.2 generated by the remote computer 8; an audio data pointer R.AUD.PTR that references a second audio data R.AUD.2 generated by the remote computer 8; a derived data pointer R.BAR.PTR that references a second derived data R.BAR.2 interpreted from bar code images, to include QR images, wherein the derived data is generated by the remote computer 8.; and/or references REF and additional pointers PTR to additional data stored within and/or available to or via one or more mobile devices 4, one or more remote computers 8, and/the network 2.

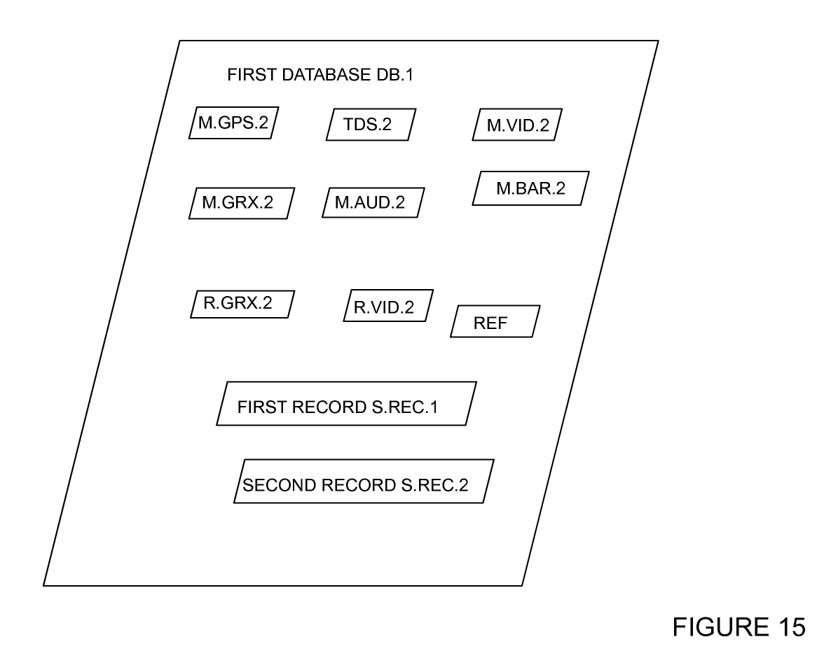

Referring now to the Figures and particularly to FIG. 15, FIG. 15 is a schematic illustration of a plurality of data referenced by the second session record S.REC.2 as optionally stored partially, completely, and/or distributively within the network 2, one or more mobile devices 4, and one or more remote computers 8.

One skilled in the art will recognize that the foregoing examples are not to be taken in a limiting sense and are simply illustrative of at least some of the aspects of the present invention.

What is claimed is:

1. A method comprising:
establishing an inspection criteria;
identifying an inspection site;
establishing a visual image and audio transmission session between the inspection site and a remote site;
rendering a video image of a view of the inspection site at the remote site; and
recording a determination of at least one aspect of the inspection site on the basis of the inspection criteria and information transferred in the visual image and audio transmission session.

2. A method in accordance with claim 1 wherein the visual image is an element of a video stream comprising a plurality of video images

3. A method in accordance with claim 1 further comprising:
providing a geolocational module at the inspection site; and
transmitting a geolocational reading to the remote site as generated by the geolocational module at the inspection site.

4. A method in accordance with claim 3 wherein the geolocational reading includes a date/time stamp datum.

5. A method in accordance with claim 1 further comprising:
enabling an alteration of the visual image; and
storage of the altered visual image at the remote site.

6. A method in accordance with claim 5 further enabling storage of the altered visual image in a hand held device.

7. A method in accordance with claim 5, wherein the alteration of the visual image is enabled and performed at the inspection site.

8. A method in accordance with claim 5, wherein the alteration of the visual image is enabled and performed at the remote site.

9. A method in accordance with claim 8, wherein a further alteration of the visual image is further enabled and performed at the inspection site.

10. A method in accordance with claim 8, wherein the alteration of the visual image is rendered at the inspection site.

11. A method in accordance with claim 5, wherein the alteration of the visual image indicates a lack of compliance with the inspection criteria.

12. A method in accordance with claim 5, wherein the alteration of the visual image indicates a compliance with the inspection criteria.

13. A method comprising:
providing a portable audio-visual data acquisition and communication device (“portable device”) at an inspection site;
establishing a visual image and audio transmission session between the portable device and a remote computer;
rendering a video image of a view of the inspection site at the remote computer;
enabling the remote computer to alter the video image;
recording an altered visual image associable with at least one aspect of the inspection site; and
associating the altered visual image with an inspection requirement applicable to the inspection site.

14. A method in accordance with claim 13, further comprising associating the altered visual record with an identifier of the inspection site.

15. A method in accordance with claim 13, further comprising associating an audio record with the altered visual image.

16. A method in accordance with claim 13, further comprising rendering the altered visual image at the portable device.

17. A method in accordance with claim 13, further comprising associating a geolocational datum of the portable device with the altered visual image.

18. A method in accordance with claim 13, further comprising associating a time/date stamp with the altered visual image.

19. A system comprising:
means to confirm a geolocational position of a portable device;
means to receive a visual image transmitted from the portable device;
means to associate the visual image and the geolocational position with an inspection requirement;
means to alter the visual image to indicate a feature that is subject to the inspection requirement; and
means to store and associate the altered visual image and the geolocational position with the inspection requirement.

20. The system of claim 19, further comprising means to render the altered image by the portable device.
